(19) United States
(12) Patent Application Publication
(10) Pub. No.: US 2024/0322721 A1
(43) Pub. Date: Sep. 26, 2024

(54) METHOD FOR DETERMINING AN INITIAL POSITION OF A ROTOR OF A BRUSHLESS MOTOR AND BRUSHLESS MOTOR

(71) Applicant: Dyson Technology Limited, Wiltshire (GB)

(72) Inventor: Máté HORVÁT, Swindon (GB)

(73) Assignee: Dyson Technology Limited, Wiltshire (GB)

(21) Appl. No.: 18/278,385

(22) PCT Filed: Feb. 16, 2022
(86) PCT No.: PCT/GB2022/050415

§ 371 Date: Aug. 22, 2023

(30) Foreign Application Priority Data
Feb. 25, 2021 (GB) 2102701.6

(51) Int. Cl. H02P 21/18; H02P 25/026; H02P 25/03

(52) U.S. Cl. CPC H02P 21/18; H02P 25/026; H02P 25/03; H02P 2203/03

(57) ABSTRACT

A method is described for determining an initial position of a rotor of a brushless motor. The method includes determining a rise time difference for each of three different pairs of voltage vectors, and determining the initial position of the rotor based on the rise time differences. Determining the rise time difference for a pair of voltage vectors includes applying a first of the voltage vectors to phases of the motor, and measuring a first time period for current in the phases to rise to a current limit. A second of the voltage vectors is then applied to the phases, and a second time period is measured for current in the phases to reach the current limit. The rise time difference is then defined by a difference between the first time period and the second time period.

### FIELD OF THE INVENTION

The present invention relates to determining an initial position of a rotor of a brushless motor.

### BACKGROUND OF THE INVENTION

In order to start a brushless motor, knowledge of the initial position of the rotor may be necessary in order to ensure that a voltage of the appropriate polarity is applied to the appropriate phases. The motor may include one or more sensors for determining the initial position of the rotor, such as Hall-effect sensors or an optical encoder. Whilst the component cost of the sensors may be relatively inexpensive, integrating the sensors within the motor may be challenging, particularly in a compact arrangement. Sensorless schemes for determining the initial position of the rotor are known. In one example, the phases are excited for a period sufficiently long to cause the rotor to rotate to a known position. However, this can result in backward rotation of the rotor, which may be undesirable. In another example, the initial position of the rotor may be determined by a process known as a high-frequency voltage injection. Whilst this process has the advantage that the rotor is not driven forwards or backwards, it is relatively complicated to implement, requires accurate sampling of the high-frequency currents, and has higher losses.

### SUMMARY OF THE INVENTION

The present invention provides a method of determining an initial position of a rotor of a brushless motor, the method comprising: determining a rise time difference for each of three different pairs of voltage vectors, wherein each pair of voltage vectors comprises a first voltage vector and a second opposite voltage vector, and determining the rise time for a pair of voltage vectors comprises: (i) applying the first voltage vector to phases of the motor; (ii) measuring a first time period for current in the phases to rise to a current limit; (iii) applying the second voltage vector to the phases; (iv) measuring a second time period for current in the phases to rise to the current limit; and (v) determining a difference between the first time period and the second time period; and determining the initial position of the rotor based on the rise time differences.

With the method of the present invention, the initial position of the rotor may be determined in a relatively simple way. In particular, the initial rotor position may be determined without the need for high-frequency voltage injection. Moreover, the first time period and the second time period may be sufficiently short that no or relatively little movement of the rotor occurs. As a result, the initial position of the rotor may be determined without driving the rotor backwards.

The method may comprise determining the initial position of the rotor based on the signs of the rise time differences. Irrespective of the initial position of the rotor, two of the rise time differences will have the same sign, and the third rise time difference will have the opposite sign. This then gives rise to six possible permutations. Accordingly, by comparing the signs of the rise time differences, the initial position of the rotor may be determined with a resolution of 60 electrical degrees (i.e. 360/6 electrical degrees).

The method may comprise determining the initial position of the rotor based on a comparison of those rise time differences having the same sign. This then gives rise to twelve possible permutations. As a result, the initial position of the rotor may be determined with a resolution of 30 electrical degrees (i.e. 360/12 electrical degrees).

Determining the initial position of the rotor may comprise determining that the rotor is in one of N sectors based on the rise time differences, each sector spanning 360/N electrical degrees.

Determining the initial position of the rotor may comprise determining an angle of the rotor within the sector, wherein the angle is defined as function of one of the rise time differences. In particular, the angle may be defined as function of a reference rise time difference, wherein the reference rise time difference is that rise time difference having a value of zero when the rotor is at a position corresponding to the start or end of the sector. By defining an angle (within the sector) as a function of one of the rise time differences, the position of the rotor may be determined with greater resolution.

The angle may be defined as a function of (i) one of the rise time differences multiplied by a scaling factor, or (ii) one of the rise time differences divided by another of the rise time differences. Where the angle is defined as a function of one rise time difference divided by another rise time difference, the two rise time differences may have the same sign. By defining the angle as a function of the rise time difference multiplied by a scaling factor, a relatively accurate determination of the rotor position may be achieved when the profile of the rise time difference (i.e. how the rise time difference varies with rotor position over the sector) is substantially linear. By defining the angle as a function of the rise time difference divided by another of the rise time differences, the rotor position may be determined without the need to generate or calculate a scaling factor. Additionally, the same function may be used with different current limits. By contrast, when using a scaling factor, a different scaling factor may be required for a different current limit.

The scaling factor may depend on a magnitude of the current limit. More particularly, a lower scaling factor may be defined for a higher current limit. As a result, relatively accurate determination of the rotor position may be achieved for a motor or motors having different current limits.

The angle may be defined as 360/N multiplied by a normalisation factor. The normalisation factor is then defined as a function of one of the rise time differences and has a value of between 0 to 1. More particularly, the normalisation factor may be defined as a function of one of the rise time differences divided by another of the rise time differences, the two rise time differences having the same sign.

Determining the initial position of the rotor comprises determining that the rotor is at angle defined by the sum of a coarse angle and a fine angle. The coarse angle is then defined as (360/N)*(M−1), where M is one of N sectors, each sector spans 360/N electrical degrees, and M is determined from a comparison of the rise time differences and has an integer value of between 1 and N. The fine angle is defined as a function of one of the rise time differences and has a value of between 0 and 360/N. As a result, the initial position of the rotor may be determined to a relatively high resolution.

The present invention also provides a brushless motor comprising a rotor, a stator having a plurality of phases, and a control system configured to perform a method as described in any one of the preceding paragraphs.

The control system may comprises an inverter, at least one current sensor, a gate driver module, and a controller. The inverter is then coupled to each of the phases, the current sensor outputs a signal indicative of current in the phases, and the gate driver module drives the opening and closing of switches of the inverter in response to control signals from the controller. The controller determines the rise time difference for each pair of voltage vectors by (i) outputting control signals to close a first set of switches of the inverter to apply the first voltage vector to the phases, (ii) monitoring the signal of the current sensor and measuring the first time period; (iii) outputting control signals to close a second set of switches of the inverter to apply the second voltage vector to the phases; (iv) monitoring the signal of the current sensor and measuring the second time period; and (v) determining the difference between the first time period and the second time period; and the controller determines the initial position of the rotor by comparing the rise time differences.

### BRIEF DESCRIPTION OF THE DRAWINGS

Embodiments will now be described, by way of example, with reference to the accompanying drawings in which:

FIG. 1 is a sectional view through a brushless motor;

FIG. 2 is a schematic diagram of the brushless motor;

FIG. 3 is a flow diagram of a method for determining the initial position of the rotor of the brushless motor;

FIG. 4 is a table detailing different pairs of voltage vectors, along with the states of the switches of the inverter of the motor, and the resulting phase voltages when the phases of the motor are star-connected and delta-connected;

FIG. 5 is a flow chart of a method for determining the rise time difference for a pair of voltage vectors;

FIG. 6 is a graph illustrating the variation in the rise time difference with rotor position for three different pairs of voltage vectors;

FIG. 7 is a flow diagram of a method for determining the initial position of the rotor based on the rise time differences; and

FIG. 8 is a table detailing the various permutations for the rise time differences for twelve different sectors, each sector spanning 30 electrical degrees.

### DETAILED DESCRIPTION OF THE INVENTION

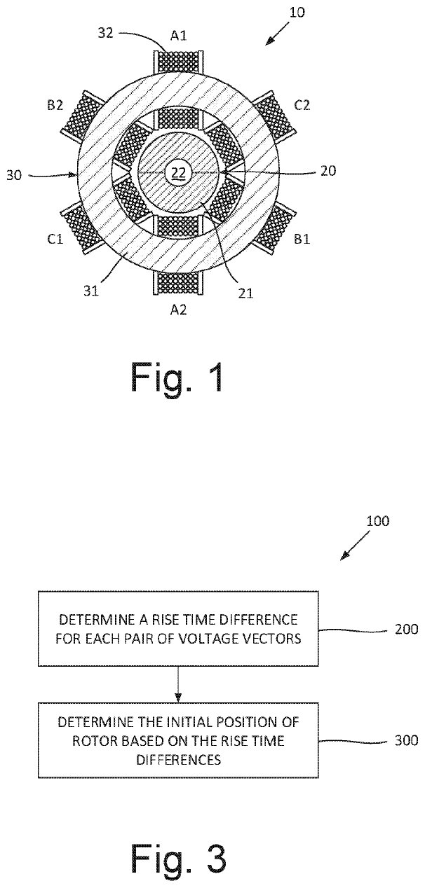

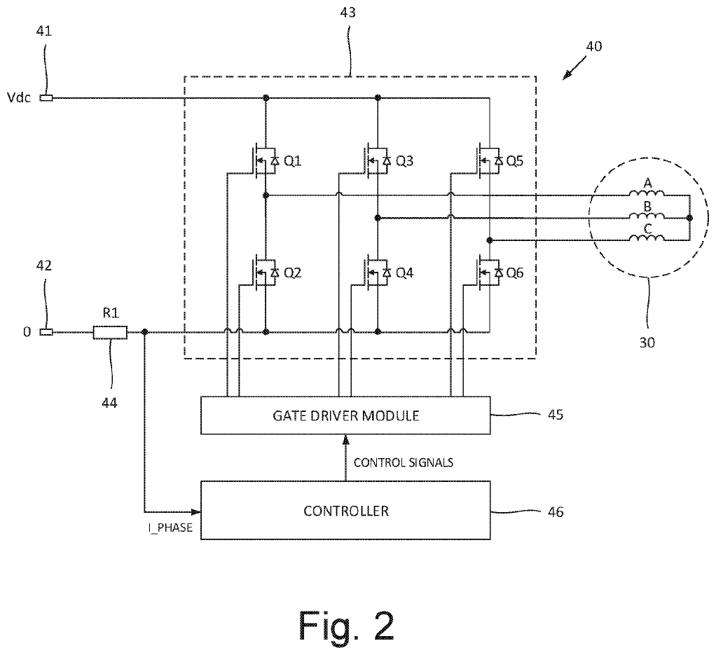

The brushless motor 10 of FIGS. 1 and 2 comprises a rotor 20, a stator 30, and a control system 40.

The rotor 20 comprises a permanent magnet 21 secured to a shaft 22. In the particular example shown in FIG. 1, the rotor 20 comprises a two-pole ring magnet 21. However, the rotor 20 might comprise an alternative number of poles. Moreover, rather than a ring magnet 21, the rotor 20 may comprise a yoke to which permanent magnets are attached (surface permanent magnet) or embedded (interior permanent magnet).

The stator 30 comprises a stator core 31 and a plurality of coils 32 that define a plurality of phases, labelled A, B and C. In the particular example illustrated in the Figures, the stator core 31 is slotless and each phase (e.g. A) comprises two coils (e.g. A1 and A2) connected in series or in parallel. However, the stator core 31 might equally be slotted, and each phase A,B,C may comprise fewer or additional coils. In the example shown in FIG. 2, the phases are connected in a star configuration. However, both configurations are possible and are considered below . . .

The control system 40 comprises a pair of terminals 41,42, an inverter 43, a current sensor 44, a gate driver module 45, and a controller 46.

The terminals 41,42 are connected or connectable to a power supply (not shown) supplying a DC voltage.

The inverter 43 is a three-phase inverter and comprises three legs, each leg comprising a pair of power switches Q1-Q6. The inverter 43 is connected to each of the three phases A, B, C of the stator 30. More particularly, each leg is connected to a terminal of a respective phase.

The current sensor 44 comprises a sense resistor R1 located between the inverter 43 and the zero-voltage terminal 42. The voltage across the current sensor 44 is output as signal I_PHASE, and provides a measure of the phase current during excitation. The use of a resistor provides a cost-effective means for sensing the phase current. However, other types of current sensor, such as a current transducer, may alternatively be used. Moreover, whilst in this particular example the control system 40 comprises a single current sensor, the control system 40 could conceivably comprise a plurality of current sensors. For example, the control system 40 may comprise a sense resistor on each leg (high-side or low-side) or line of the inverter 43.

The gate driver module 45 drives the opening and closing of the switches Q1-Q6 of the inverter 43 in response to control signals output by the controller 46.

The controller 46 generates control signals for controlling the switches Q1-Q6 of the inverter 43. The control signals are output to the gate driver module 45, which in response drives the opening and closing of the switches Q1-Q6.

Referring now to FIG. 3, the control system 40 employs a sensorless method 100 for determining the initial position of the rotor 20. The method 100 comprises determining 200 a rise time difference for each of three different pairs of voltage vectors, and determining 300 the initial position of the rotor 20 based on the rise time differences.

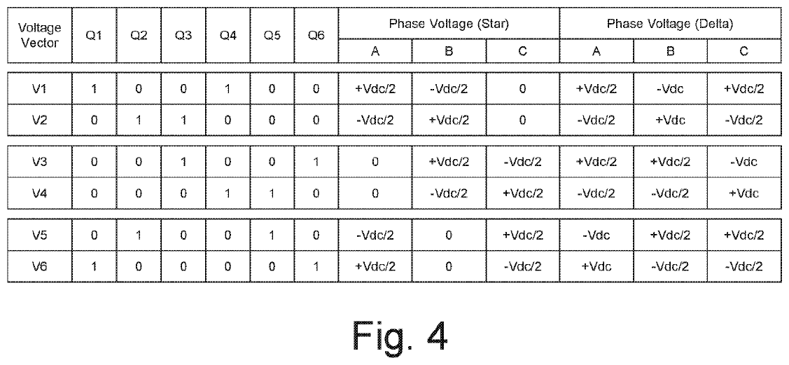

FIG. 4 details the different pairs of voltage vectors, along with the states of the switches Q1-Q6, and the resulting phase voltages when the phases are star-connected and delta-connected. Each pair of voltage vectors comprises a first voltage vector and a second opposite voltage vector. Consequently, when the second voltage vector is applied to the phases, the voltage across each phase has the same magnitude but the opposite polarity to that when the first voltage vector is applied to the phases. So, for example, when the voltage vector V1 is applied to star-connected phases, a voltage of +Vdc/2 is applied to phase A and a voltage of −Vdc/2 is applied to phase B. When the opposite voltage vector V2 is applied the phases, a voltage of −Vdc/2 is applied to phase A and a voltage of +Vdc/2 is applied to phase B.

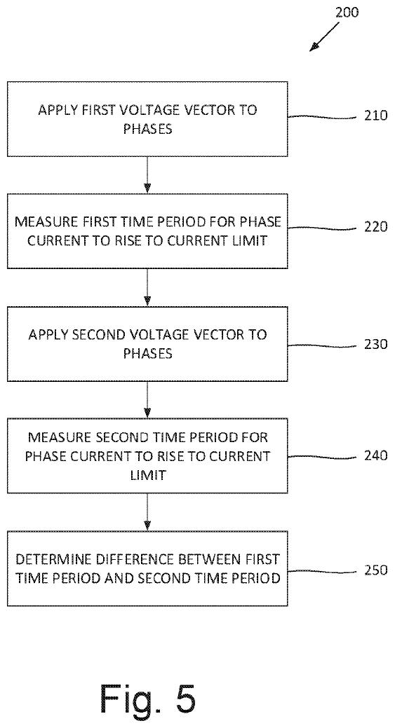

FIG. 5 illustrates a method 200 for determining the rise time difference for a particular pair of voltage vectors. The method is repeated for each of the three different pairs of voltage vectors.

The method 200 comprises applying 210 the first of the voltage vectors to the phases A,B,C. So, for example, in order to apply the voltage vector V1 to the phases, the controller 46 generates control signals that close switches Q1 and Q4. In order to apply the voltage vector V3 to the phases, the controller 46 generates control signals that close switches Q3 and Q6. And in order to apply the voltage vector V5 to the phases, the controller 46 generates control signals that close switches Q5 and Q2.

The method 200 further comprises measuring 220 a first time period for current in the phases to rise to a current limit. So, for example, upon generating the control signals to apply the first voltage vector to the phases, the controller 46 monitors I_PHASE and measures the time taken for current to increase from zero to the current limit. This time is then stored by the controller 46 as the first time period.

The applied voltage vector is then removed from the phases. This may be achieved by opening all of the switches Q1-Q6 of the inverter 43. Inductive current is then returned to the power supply via the body diodes of the switches. Alternatively, rather than opening all of the switches, one or more switches may be closed such that a path is provided for the inductive current to circulate or freewheel around a high-side loop or a low-side loop of the inverter. In both instances, with the voltage vector removed, the phase current falls to zero. In the particular example illustrated in FIG. 2, the current sensor 44 is incapable of sensing current in the phases when the voltage vector is removed. Consequently, after the voltage vector has been removed, the controller 46 waits a set period of time sufficient for current in the phases to decrease to zero.

With the phase current at zero, the method 200 comprises applying 230 the second of the voltage vectors to the phases. So, for example, in order to apply the voltage vector V2 to the phases, the controller 46 generates control signals that close switches Q3 and Q2. In order to apply the voltage vector V4 to the phases, the controller 46 generates control signals that close switches Q5 and Q4. And in order to apply the voltage vector V6 to the phases, the controller 46 generates control signals that close switches Q1 and Q6.

The method 200 then comprises measuring 240 a second time period for current in the phases to rise to the current limit. Again, upon generating the control signals to apply the second voltage vector to the phases, the controller 46 may monitor I_PHASE signal and measure the time taken for current to increase from zero to the current limit. This time is then stored by the controller 46 as the second time period.

Finally, the method 200 comprises determining 250 the difference between the first time period and the second time period. This may be achieved by subtracting the first time period from the second time period, or vice versa, so long as the same operation is used when determining the time difference for each pair of voltage vectors. For the purposes of the present discussion, the rise time differences will be labelled: TD_12, TD_34 and TD_56, where TD_12 is the rise time difference for the pair of voltage vectors V1 and V2, and so on.

When a voltage is applied to the phases, the resulting phase current generates a stator field. As the phase current increases, the density of the stator flux increases and eventually the stator core 31 begins to saturate. As the stator core 31 saturates, the inductance of the phases decreases and therefore the phase current rises at a faster rate. Depending on the applied voltage vector and the position of the rotor 20, the rotor flux will either contribute to or oppose the stator flux. When the rotor flux contributes to the stator flux, saturation of the stator core 31 occurs more quickly, i.e. saturation occurs at a lower current. As a result, the phase current takes a shorter period of time to reach the current limit. Conversely, when the rotor flux opposes the stator flux, saturation of the stator core 31 occurs more slowly (i.e. saturation occurs at a higher current). As a result, the phase current takes a longer period of time to reach the current limit.

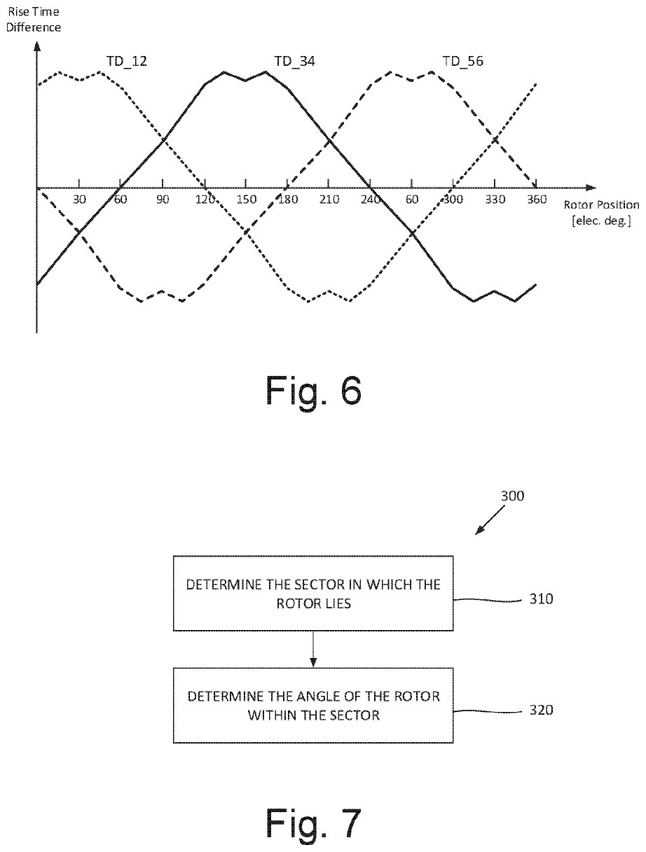

FIG. 6 illustrates the variation in each of the rise time differences with rotor position. It can be seen that, for this particular motor 10, the profile of each of the rise time differences resembles a trapezoid. Whilst the particular profiles will depend on the electromagnetic characteristics of the motor, each of the rise time differences will nevertheless vary with rotor position. The control system 40 then exploits this behaviour to determine the initial position of the rotor 20.

FIG. 7 illustrates a method 300 for determining the initial position of the rotor 20 based on the rise time differences.

The method 300 comprises determining 310 that the position of the rotor 20 is in one of N sectors, with each sector spanning 360/N electrical degrees. As is evident from FIG. 6, irrespective of the position of the rotor 20, one of the rise time differences is positive, one of the rise time differences is negative, and one of the rise time differences is either positive or negative. For the purposes of the present discussion, a rise time difference of zero may be regarded as either positive or negative. Two of rise time differences therefore have the same sign, and a third rise time difference has the opposite sign. This gives rise to six possible permutations: ++−; +−+; −++; −−+; −+−; −−+. The method 300 is therefore capable of determining that the rotor 20 is in one of six sectors, with each sector spanning 60 electrical degrees, based solely on the signs of the rise time differences. However, in addition to the signs of the rise time differences, the two rise time differences having the same sign may have a different value. Accordingly, by comparing the values of the two rise time differences having the same sign, the number of possible permutations may be doubled from six to twelve. The method 300 is therefore capable of determining that the rotor is in one of twelve sectors, with each sector spanning 30 electrical degrees, based on the rise time differences.

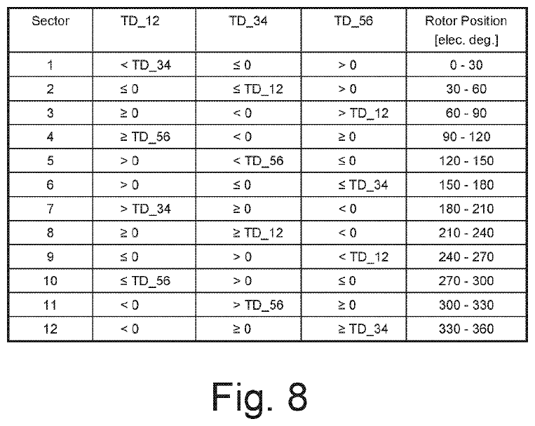

FIG. 8 details the various permutations for the rise time differences for the twelve sectors. For example, if TD_12 and TD_34 are positive, and TD_34 is greater than TD_12 then the initial rotor position is determined to lie in the sector spanning 210 to 240 electrical degrees.

The method 300 further comprises determining 320 the angle of the rotor within the sector.

Each sector spans 360/N electrical degrees, where N is the total number of sectors. The angle of the rotor within the sector therefore lies between 0 and 360/N electrical degrees. As noted above, in this particular example, the method is capable of determining that the rotor is in one of twelve sectors based on the rise time differences. Accordingly, each sector spans 30 electrical degrees, and therefore the angle of the rotor within the sector is between 0 and 30 electrical degrees.

It can be seen in FIG. 8 that for each 30 degree sector there is a rise time difference that is zero either at the start or at the end of the sector. For the purposes of the present discussion, this particular rise time difference will hereafter be referred to as the reference rise time difference TD_RF. So, for example, in sector 1 the reference rise time difference is TD_34, and in sector 2 it is TD_12. The angle of the rotor within each sector may be defined as a function of the reference rise time difference.

As is evident from FIG. 6, for this particular motor 10, the absolute value of the reference rise time difference varies linearly over the respective sector. Accordingly, the angle may be defined as a linear function of the reference rise time difference. In particular, the absolute value of the reference rise time difference may be multiplied by a scaling factor S. The absolute value of the reference rise time difference may increase (i.e. have a positive gradient) or decrease (i.e. have a negative gradient) over the relevant sector. For example, in sector 1, the absolute value of TD_34 increases from zero at the start of the sector to some value at the end of the sector. In sector 2, on the other hand, the absolute value of TD_12 decreases from some value at the start of the sector to zero at the end of the sector. The angle of the rotor may therefore be defined as ABS(TD_RF)*S when the absolute value of the reference rise time difference TD_RF has a positive gradient, and 360/N-ABS(TD_RF)*S when the absolute value of the reference rise time difference has a negative gradient. In this particular example, the gradient of the absolute value of the reference rise time difference is positive for each odd-numbered sector and negative for each even-numbered sector. Accordingly, the angle A of the rotor within a particular sector may be defined as:

A=ABS(TD_RF)*S for odd-numbered sectors

A=360/N-ABS(TD_RF)*S for even-numbered sectors

where N is the total number of sectors, ABS(TD_RF) is the absolute value of the reference rise time difference TD_RF, and S is the scaling factor.

As an alternative to a linear function, the angle of the rotor within each sector may be defined by a non-linear function of the reference rise time difference. For each sector, one of the rise time differences has the same sign (i.e. positive or negative) as the reference rise time difference, and one of the rise time differences has the opposite sign. So, for example, in sector 1 TD_12 has the same sign and TD_56 has the opposite sign as the reference rise time difference TD_34. The rise time difference having the same sign as the reference rise time difference has an absolute value that is greater than or equal to the reference rise time difference, and has a gradient that is roughly the same shape but opposite sign to that of the reference rise time. The angle of the rotor within each sector may therefore be defined by a function of the reference rise time difference divided by the other rise time differences having the same sign. Dividing the reference rise time difference in this way produces a normalisation factor Z of between 0 and 1. This normalization factor may then be multiplied by 360/N electrical degrees (i.e. the size of each sector) in order to determine the angle of the rotor within the sector.

Again, the absolute value of the reference rise time difference may have a positive gradient or a negative gradient. Accordingly, the angle of the rotor within a sector may be expressed as (360/N)*Z for those sectors for which the absolute value of the reference rise time difference has a positive gradient, and (360/N)*(1-Z) for those sectors for which the absolute value of the reference rise time difference has a negative gradient. Accordingly, the angle A of the rotor within a particular sector may be defined as:

A=(360/N)*Z for odd-numbered sectors

A=(360/N)*(1-Z) for even-numbered sectors

where Z is a function of TD_RF/TD_XY, TD_RF is the reference rise time difference, and TD_XY is the other of the rise time differences having the same sign as the reference rise time difference.

The normalisation factor Z may be defined simply as TD_RF/TD_XY. However, in the present example, where the gradient of the reference rise time is almost linear, improvements in the accuracy of the rotor position were found when using the square root of TD_RF/TD_XY, i.e. Z=SQRT(TD_RF/TD_XY). Other functions of TD_RF/TD_XY are of course possible and may be selected according to the profile of the rise time differences so as to further improve the accuracy of the rotor position.

With the particular behaviour observed in FIG. 6, in which the gradient of the reference rise time difference is almost linear over its respective sector, the use of a scaling factor S was found to give the most accurate determination of the rotor position. However, defining the angle in this way requires the scaling factor to be predefined. Additionally, the scaling factor S depends on the gradient of the reference rise time difference. In particular, a lower scaling factor is employed for a steeper gradient. The gradient of the rise time differences depends on the magnitude of the current limit that is used when determining the rise time differences. As a result, a different scaling factor is ideally defined for a different current limit. When the angle is defined by the reference rise time difference divided by another of the rise time differences, the accuracy in the rotor position is slightly worse, at least for this particular example. However, there is no need to generate or calculate a scaling factor, and the same function may be used with different current limits.

The angular position of the rotor is determined from both the sector in which the rotor lies and the particular angle of the rotor within the sector. The position of the rotor may therefore be regarded as the sum of a coarse angle and a fine angle. The coarse angle is defined by the sector in which the rotor lies, which in turn is determined by a comparison of the rise time differences. The coarse angle may be defined as (360/N)*(M−1), where M is the sector number of the rotor determined from a comparison of the rise time differences and has a value of between 1 and N. The fine angle corresponds to angle A described above, and is defined by a function of the reference rise time difference and has a value of between 0 and 360/N. Accordingly, by way of example, the position POS of the rotor may be defined as:

POS=(360/N)*(M−1)+ABS(TD_RF)*S when M is odd

POS=(360/N)*(M-1)+360/N-ABS(TD_RF)*S when M is even

or

POS=(360/N)*(M-1)+(360/N)*(TD_RF/TD_XY) when M is odd

POS=(360/N)*(M-1)+(360/N)*(1−(TD_RF/TD_XY)) when M is even

or

POS=(360/N)*(M-1)+(360/N)*SQRT(TD_RF/TD_XY) when M is odd

POS=(360/N)*(M-1)+(360/N)*(1-SQRT(TD_RF/TD_XY)) when M is even

With the method described above, the initial position of the rotor may be determined with relatively good resolution and accuracy in a relatively simple way. In particular, the initial rotor position may be determined without the need for high-frequency voltage injection. Additionally, the initial position of the rotor may be determined without driving the rotor backwards.

The method may be regarded as comprising two steps. In the first step, the position of the rotor is determined with a coarse resolution. In particular, the position of the rotor is determined as lying within one of N sectors, with each sector spanning 360/N electrical degrees. As noted above, the position of the rotor may be determined to a resolution of 60 electrical degrees by comparing the signs of the rise time differences. This resolution may be increased to 30 electrical degrees by additionally comparing those rise time differences having the same sign. In the second step, the angle of the rotor within a particular sector is determined. As a result, the position of the rotor may determined with a much finer resolution.

Conceivably, just the first step of the method may be employed in order to determine the position of the rotor. This may be of use, for example, when the stator is slotted and the resulting cogging torque causes the rotor to park at one of a number of predetermined positions. In the instance, the coarse resolution may be sufficient to determine at which of the predetermined positions the rotor has parked. However, for a slotted motor or other motor having a relatively low cogging torque, the rotor may park at any position. In this instance, the additional resolution provided by the second step ensures that the initial position of the rotor may be determined with sufficient precision that the rotor can be started.

1. A method of determining an initial position of a rotor of a brushless motor, the method comprising:
determining a rise time difference for each of three different pairs of voltage vectors, wherein each pair of voltage vectors comprises a first voltage vector and a second opposite voltage vector, and determining the rise time for a pair of voltage vectors comprises:
(i) applying the first voltage vector to phases of the motor;
(ii) measuring a first time period for current in the phases to rise to a current limit;
(iii) applying the second voltage vector to the phases;
(iv) measuring a second time period for current in the phases to rise to the current limit; and
(v) determining a difference between the first time period and the second time period; and
determining the initial position of the rotor based on the rise time differences.

2. The method as claimed in claim 1, wherein the method comprises determining the initial position of the rotor based on the signs of the rise time differences.

3. The method as claimed in claim 2, wherein the method comprises determining the initial position of the rotor based on a comparison of those rise time differences having the same sign.

4. The method as claimed in claim 1, wherein determining the initial position of the rotor comprises determining that the rotor is in one of N sectors based on the rise time differences, each sector spanning 360/N electrical degrees.

5. The method as claimed in claim 4, wherein determining the initial position of the rotor comprises determining an angle of the rotor within the sector, and the angle is defined as function of one of the rise time differences.

6. The method as claimed in claim 5, wherein the angle is defined as a function of (i) one of the rise time differences multiplied by a scaling factor, or (ii) one of the rise time differences divided by another of the rise time differences.

7. The method as claimed in claim 6, wherein the scaling factor depends on a magnitude of the current limit.

8. The method as claimed in claim 5, wherein the angle is defined as 360/N multiplied by a normalisation factor, and the normalisation factor is defined as a function of one of the rise time differences and has a value of between 0 to 1.

9. The method as claimed in claim 1, wherein determining the initial position of the rotor comprises determining that the rotor is at angle defined by the sum of a coarse angle and a fine angle,
the coarse angle is defined as (360/N)*(M−1), where M is one of N sectors, each sector spans 360/N electrical degrees, and M is determined from a comparison of the rise time differences and has an integer value of between 1 and N, and
the fine angle is defined as a function of one of the rise time differences and has a value of between 0 and 360/N.

10. A brushless motor comprising a rotor, a stator having a plurality of phases, and a control system configured to perform the method as claimed in claim 1.

11. The brushless motor as claimed in claim 10, wherein the control system comprises an inverter, at least one current sensor, a gate driver module, and a controller; the inverter is coupled to each of the phases; the current sensor outputs a signal indicative of current in the phases; the gate driver module drives the opening and closing of switches of the inverter in response to control signals from the controller; the controller determines the rise time difference for each pair of voltage vectors by (i) outputting control signals to close a first set of switches of the inverter to apply the first voltage vector to the phases, (ii) monitoring the signal of the current sensor and measuring the first time period; (iii) outputting control signals to close a second set of switches of the inverter to apply the second voltage to the phases; (iv) monitoring the signal of the current sensor and measuring the second time period; and (v) determining the difference between the first time period and the second time period; and the controller determines the initial position of the rotor by comparing the rise time differences.
